(19) United States
(12) Patent Application Publication
(10) Pub. No.: US 2015/0331449 A1
(43) Pub. Date: Nov. 19, 2015

(54) ATTACHABLE COMPUTER

(71) Applicant: GOWIN TECHNOLOGY INTERNATIONAL HOLDINGS LIMITED, Hong Kong (HK)

(72) Inventor: Yat Tung Ng, Hong Kong (HK)

(73) Assignee: GOWIN TECHNOLOGY INTERNATIONAL HOLDINGS LIMITED, Hong Kong (HK)

(21) Appl. No.: 14/710,641

(22) Filed: May 13, 2015

Related U.S. Application Data
(60) Provisional application No. 61/992,890, filed on May 14, 2014.

(51) Int. Cl. G06F 1/16; G06F 3/038; G06F 3/042; G06F 3/0354

(52) U.S. Cl. CPC G06F 1/1607; G06F 3/03542; G06F 3/038; G06F 3/0428

(57) ABSTRACT

An attachable computer includes a frame-structured case; a connector connecting the frame-structured case to a monitor; and a circuit board, a memory device, a microprocessor, and input and output ports provided in the frame-structured case. The memory device, the microprocessor, and the input and output ports are connected with the circuit board in electrical signal communication. The attachable computer can be attached to the monitor to form a one-piece computer. This can effectively utilize existing monitors and reduce electronic waste.

### CROSS-REFERENCE TO RELATED APPLICATIONS

This application claims the benefit of U.S. Provisional Patent Application No. 61/992,890 filed on May 14, 2014, the contents of which is hereby incorporated by reference.

### FIELD OF THE TECHNOLOGY

The present application relates to a computer, and particularly to an attachable computer.

### BACKGROUND

With the rapid development of computer engineering over the past years, all-in-one computers, such as tablet PC, are more and more popular. Computer accessories, especially computer monitors, become redundant. In order to reduce electronic wastes, the present application provides an attachable computer with a frame-structured case assembly for attaching to external visual displays, such as monitors.

### SUMMARY

An object of the present application is to provide an attachable computer that can be attached to a display device or a monitor to form a one-piece computer so that the display device or the monitor can be utilized and space can be saved.

According to one aspect, there is provided an attachable computer, including:
a frame-structured case;
a connector connecting the frame-structured case to a monitor; and
a circuit board, a memory device, a microprocessor, and input and output ports provided in the frame-structured case; and the memory device, the microprocessor, and the input and output ports being connected with the circuit board in electrical signal communication.

The connector may be a belt, a hook or a double-sided tape. The belt may be provided with adjustable devices for adjusting a tightness of the belt.

The frame-structured case may be in the form of a strip, a right-angled frame, a 3-sided frame or a 4-sided frame.

The attachable computer may further include an infrared stylus.

The frame-structured case may be provided with a sensing module, the sensing module being connected with the circuit board in electrical signal communication, the sensing module producing a touch sensitive area in a region surrounded by the frame-structured case.

The frame-structured case may be in the form of a 4-sided frame, and the attachable computer includes:
two sensing modules provided at an upper left corner and an upper right corner of the frame-structured case respectively and connected with the circuit board in electrical signal communication;
a plurality of light strips provided on three sides of the frame-structured case; and
a control board provided on the frame-structured case; wherein
the sensing module produces a touch sensitive area in a region surrounded by the frame-structured case; and
the control board is configured to calculate a relative coordinate of an object in the region; the object being detected with the sensing modules and the light strips.

The frame-structured case may have a shape that matches shape of a monitor's side frames on which the frame-structured case is attached.

A touch screen may be provided in a region surrounded by the frame-structured case.

The frame-structured case may be provided with a decorative outer region.

The frame-structured case may be provided with decorative transparent regions.

The microprocessor, the memory device and the input and output ports may be integrated on the circuit board.

The input and output ports may be mounted on one side of the frame-structured case, or on a plurality of sides of the frame-structured case.

An operating system conversion switch may be provided in the frame-structured case.

The attachable computer may be attached to a front of the monitor, or a back of the monitor.

The frame-structured case may be made of aluminium alloy or plastic.

The frame-structured case may be made of a single material. The frame-structured case may be formed of parts made of different materials. The frame-structured case may be made of metal parts and plastic parts.

In another aspect, there is provide an attachable computer, including:
a frame-structured case;
a connector connecting the frame-structured case to a monitor; and
a plurality of circuit boards connected by data lines, a memory device, a microprocessor, and input and output ports provided in the frame-structured case; and
the memory device, the microprocessor, and the input and output ports being connected with the plurality of circuit boards in electrical signal communication.

The attachable computer of the present application is advantageous in that it can be attached to a display device or a monitor to form a one-piece computer. This can effectively utilize existing display devices and monitors to reduce electronic waste.

Although the attachable computer is shown and described with respect to certain embodiments, it is obvious that equivalents and modifications will occur to others skilled in the art upon the reading and understanding of the specification. The attachable computer in the present application includes all such equivalents and modifications, and is limited only by the scope of the claims.

### BRIEF DESCRIPTION OF THE DRAWINGS

Specific embodiments of the attachable computer will now be described by way of example with reference to the accompanying drawings wherein:

FIG. 1 is an illustration of an attachable computer according to an embodiment of the present invention.

FIG. 2a is an illustration of an attachable computer to be attached to the front of a monitor.

FIG. 2b is an illustration of an attachable computer being attached to the front of a monitor.

FIG. 3a is an illustration of an attachable computer to be attached to the back of a monitor.

FIG. 3b is an illustration of an attachable computer being attached to the back of a monitor.

FIG. 4 is a perspective view showing an attachable computer being attached to a monitor by belts.

FIG. 5a shows an attachable computer assembled with a belt assembly.

FIG. 5b shows a belt assembly of FIG. 5a.

FIG. 6a shows an attachable computer assembled with a hook assembly.

FIG. 6b shows a hook assembly of FIG. 6a.

FIG. 7a shows an attachable computer assembled with a double-side tape assembly.

FIG. 7b shows a double-side tape assembly of FIG. 7a.

FIG. 8a-d shows different views of an attachable computer comprising I/O ports and switches.

FIG. 9 is an illustration of external I/O ports for cable connection.

FIGS. 10a-c are illustrations of the inner structure and configuration of an attachable computer.

FIG. 11a is an illustration of an attachable computer with a frame-structured case assembly and a glass surface.

FIG. 11b is an illustration of an attachable computer with a frame-structured case assembly without a glass surface.

FIG. 12a is an illustration of an attachable computer with a 3-side frame-structured case and an IR stylus.

FIGS. 12b and 12c are illustrations of an attachable computer with a 2-side frame-structured case respectively, and an IR stylus.

FIG. 12d is an illustration of an attachable computer with a 1-side frame-structured case and an IR stylus.

### DETAILED DESCRIPTION

Reference will now be made in detail to a preferred embodiment of the attachable computer, examples of which are also provided in the following description. Exemplary embodiments of the attachable computer are described in detail, although it will be apparent to those skilled in the relevant art that some features that are not particularly important to an understanding of the attachable computer may not be shown for the sake of clarity.

Furthermore, it should be understood that the attachable computer is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure and appended claims.

For illustration purposes, the terms “upper”, “lower”, “right”, “left”, “vertical”, “horizontal”, “top”, “bottom” appeared hereinafter relate to the invention as it is oriented in the drawings. It is understood that the invention may assume various positions, except where expressly specified to the contrary. Furthermore, it is understood that the specific devices shown in the drawings, and described in the following description, are simply exemplary embodiments of the invention. Hence, specific dimensions and other physical characteristics related to the embodiments disclosed hereinafter are not to be considered as limiting.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element or is in mechanical or electrical communication with another element.

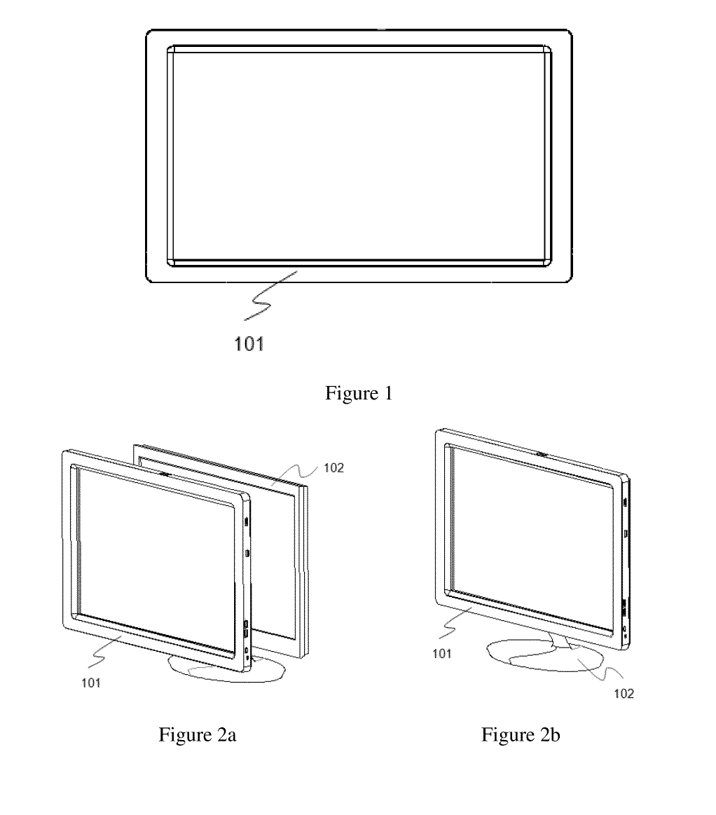

FIG. 1 is an attachable computer 101 according to an embodiment of the present application. The attachable computer 101 may have a frame-structured case which can be attached to a display device or a monitor to form a one-piece computer. The monitor can be CRT monitor, LCD monitor, LED monitor, or other types of monitor. The one-piece computer so formed can save space and can make good use of the existing monitors so as to avoid single monitors being discarded and become electronic waste in view of the fast growing of all-in-one computer products.

The attachable computer 101 may include a frame-structured case. The frame-structured case may include one or more circuit boards, a microprocessor connected to the circuit boards in electrical signal communication, a memory device, I/O ports (input and output ports), etc. The microprocessor, the memory device and the I/O ports can be integrated on the circuit boards.

The I/O ports may be mounted along the sides of the frame-structured case of the attachable computer 101. The I/O ports may be mounted on one side of the frame-structured case. The I/O ports may also be mounted on the sides of the frame-structured case respectively. Depending on actual need, the mounting of the I/O ports can be flexible.

The I/O ports may be standard ports such as USB ports, HDMI slots and SD card slots, etc. USB ports can be used for data transmission as well as power supply. For example, the USB ports can be used to connect to an external input device such as keyboard, mouse and webcam, etc. The USB ports can also be used to connect to memory sticks and external storage devices. The SD card slots can be used for connection with SD cards in order to increase storage size of the attachable computer 101. The HDMI slots can be used to connect to an external visual display. If the external visual display does not support HDMI, a HDMI-to-VGA convertor can be used.

At least one operating system (OS) can be installed in the attachable computer 101. Examples of OS may include Android, Windows, Linux, iOS, in-house developed system, or other commercially available system. When more than one operating system is installed, a system conversion switch may be provided in the frame-structured case of the attachable computer so as to facilitate conversion of the operating system.

The attachable computer 101 may further include a touch screen. Video signals of the attachable computer can be output to the touch screen. When the attachable computer is attached to a monitor, video signals can be output to the monitor by wires.

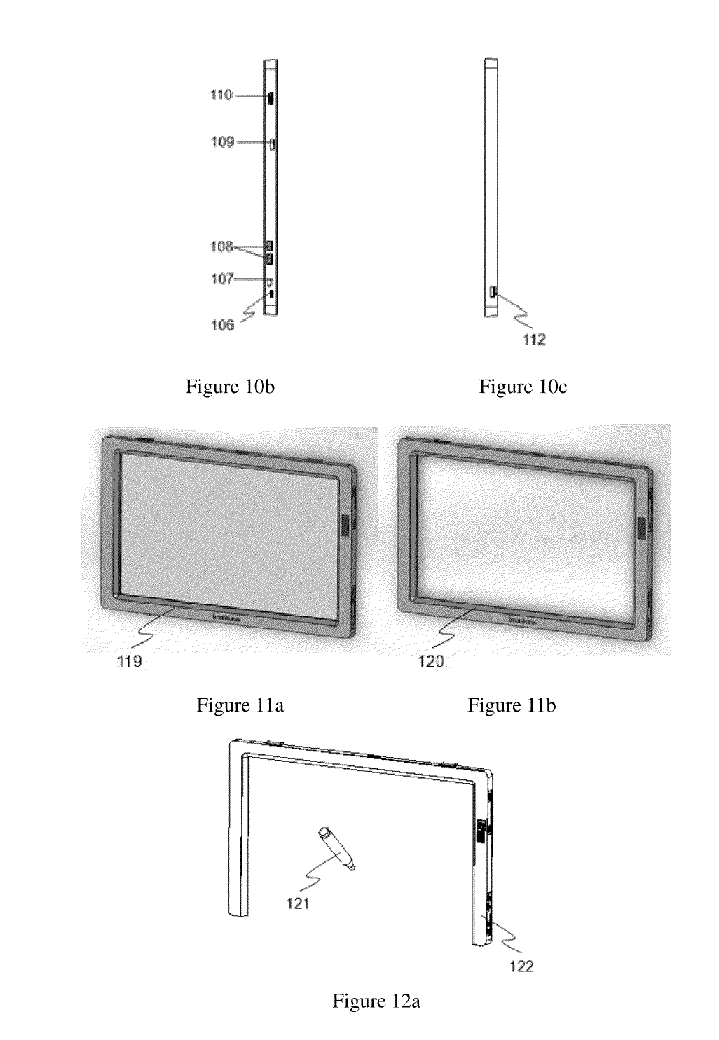

FIGS. 1 and 10a-10c show an embodiment of the attachable computer 101 of the present application. In the illustrated embodiment, the attachable computer 101 may include a frame-structured case 100. The frame-structured case 100 can be a rectangular 4-sided frame having four side frames. The shape of the frame-structured case 100 may match the shape of the side frames of a display device or a monitor to which the frame-structured case is attached. The frame-structured case 100 may be provided therein with circuit boards. Particularly, in the illustrated embodiment, the circuit boards may include an I/O circuit board 114 and a system circuit board 115. The I/O circuit board 114 and the system circuit board 115 can be connected by wires in electrical signal communication. The I/O circuit board 114 may include a USB connector 106b for power supply, a power switch 107b and USB connectors 108b for connection with external input devices. The system circuit board 115 may include a SD card connector 109b, a HDMI connector 110b and a USB connector 112b for connection with an external operating system (OS). Two sensing modules 117 may be provided at the upper left and the upper right corners of the frame-structured case 100 respectively. Light bars or strips 118 may be provided on three sides of the frame-structured case 100. With the sensing modules 117 and the light strips 118, any object appearing in a void or blank region 113 surrounded by the frame-structured case can be detected. A control board 116 may then calculate the relative coordinates. This can make the blank region 113 surrounded by the frame-structured case a touch sensitive region.

FIGS. 8a-8d, 9 and 10a-10c show that the attachable computer 101 of the present application may have a plurality of I/O ports. For example, the attachable computer 101 may include a USB port 106 for connection with a power supply cable 106a, a power switch 107 for switching on/off the attachable computer 101, a USB port 108 for connection with an external input devices 108a, a SD card slot 109 for SD cards, a HDMI slot 110 for connecting the attachable computer 101 to a monitor through a HDMI cable 110a, and a system switch 111 for changing the operating system of the attachable computer 101.

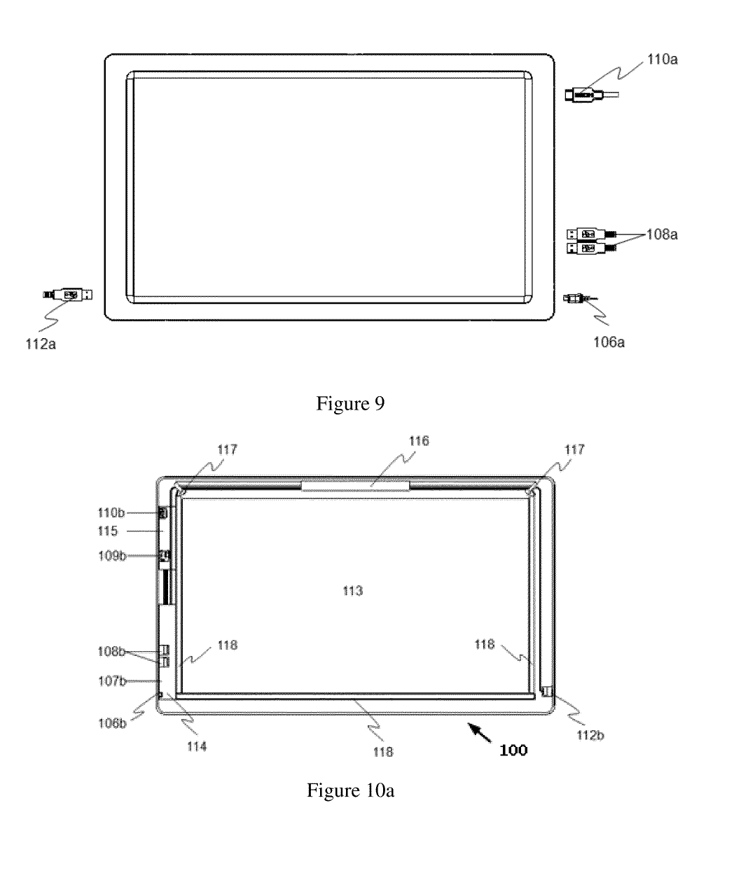

FIG. 9 shows the attachable computer 101 having a touch screen. When the attachable computer is connected to an external OS through a USB cable 112a inserted into a USB port 112, the touch screen may become a touch screen of the external operating system (OS). Furthermore, two switches may be provided on the side of the frame-structured case of the attachable computer 101. One switch may be used as a power switch, and the other switch may be used as a system conversion switch.

The frame-structured case of the attachable computer 1001 may be provided with only one circuit board. Various functional modules of the attachable computer can be integrated on that circuit board. Of course, a plurality of circuit boards may be provided. The circuit boards may perform their respective functions. The circuit boards can be connected by data lines in electrical signal communication.

FIGS. 11a and 11b show an attachable computer 119 having a touch screen (glass surface) and an attachable computer 120 without a touch screen respectively.

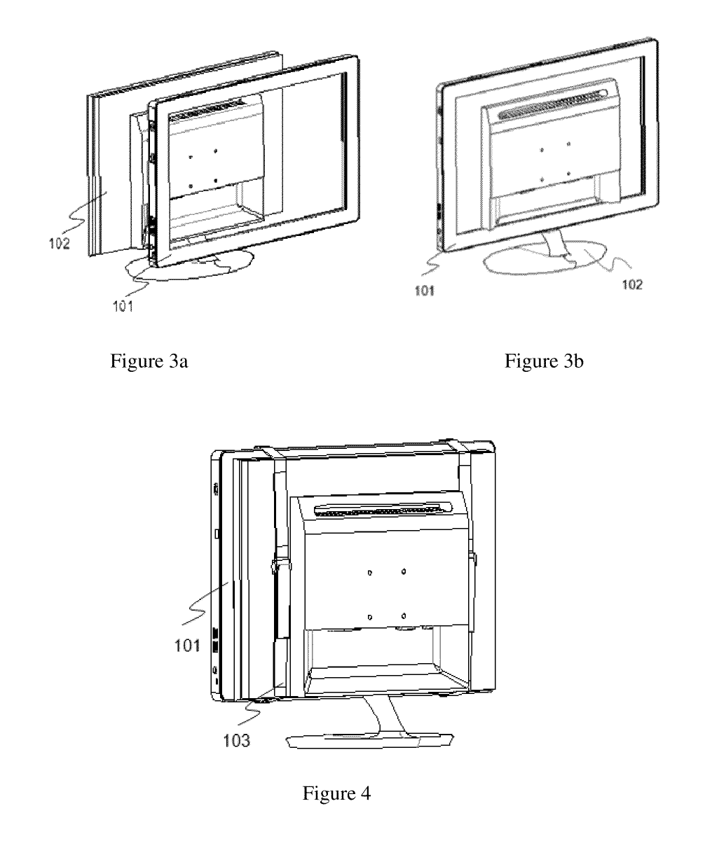

FIGS. 2a and 2b show that the attachable computer 101 can be attached to the front of a monitor 102. The attachable computer 101 can be attached to the side frames at the front of the monitor 102. The monitor 102 may be used as a monitor of the attachable computer 101 to form a one-piece computer. Since the space occupied by the attachable computer 101 is very small, the space occupied and the affect of the appearance of the monitor 102 with the attachable computer 101 attached is also very small. FIGS. 3a and 3b show that the attachable computer 101 can be attached to the back of the monitor 102. The attachable computer 101 can be attached to the side frames at the back of the monitor 102. This will not affect the front appearance of the monitor 102. Attaching at the back can more appropriately make use of space. The attachable computer 101 of the present application can be attached to the monitor in a flexible way, and is not limited to the ways shown in FIGS. 2a-2b and 3a-3b.

The attachable computer 101 of the present application can be attached to the monitor 102 by various means. Attachment can be achieved by belts, hooks, double-sided tapes or any other suitable means. The attachable computer 101 can be provided with connectors for attaching the attachable computer 101 to the monitor 102. Such connectors may include belts, hooks, double-sided tapes or any other suitable means.

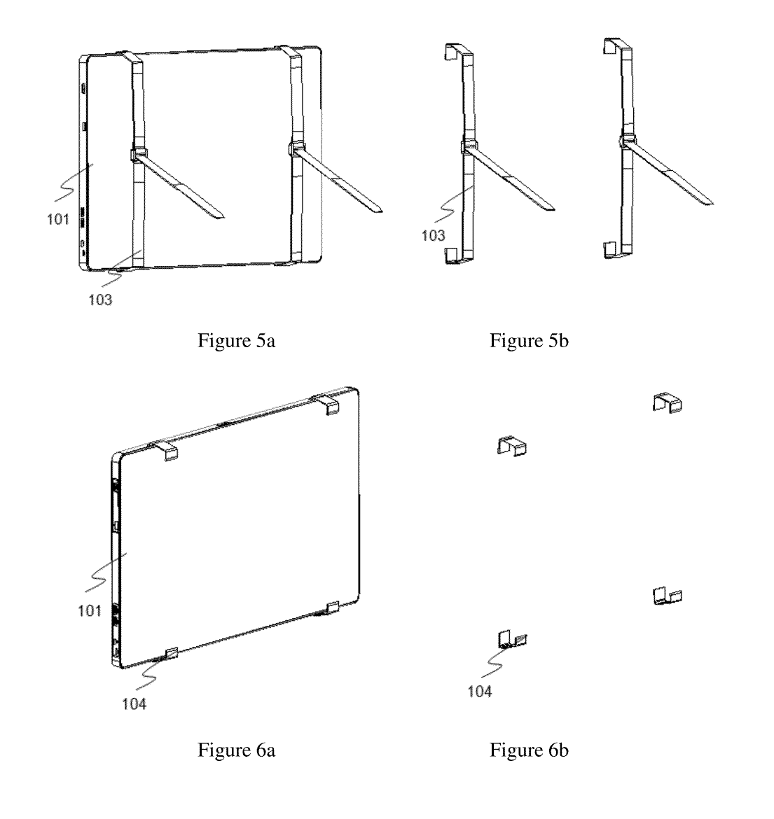

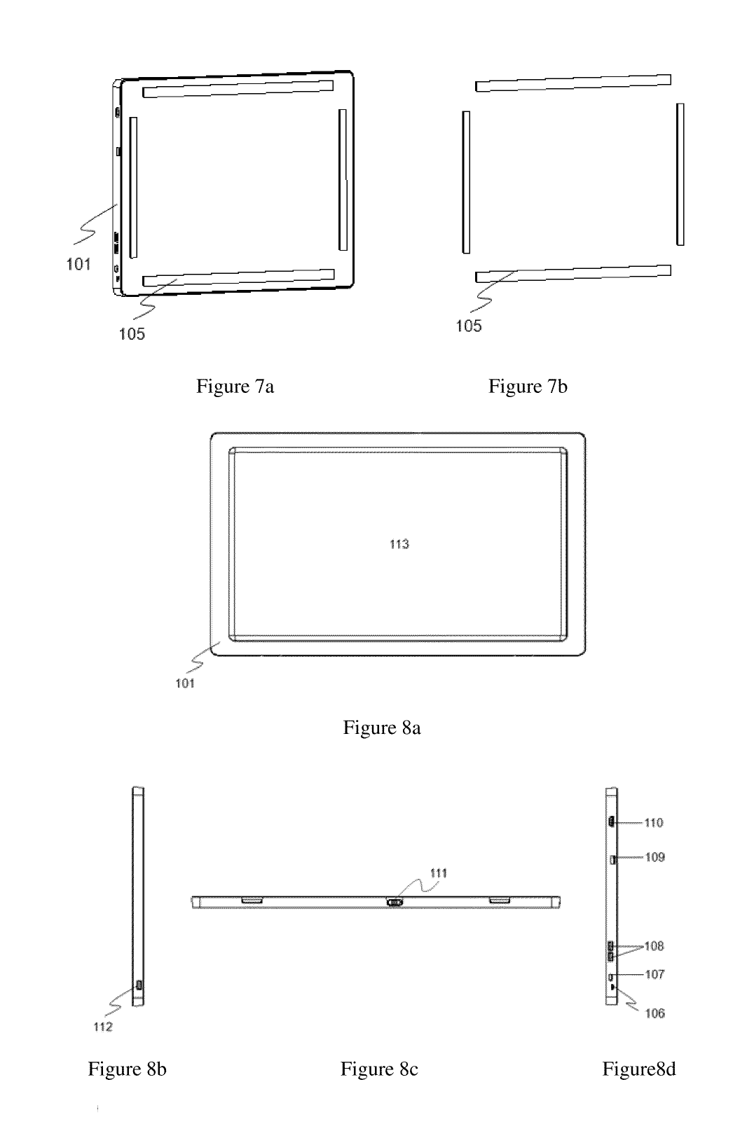

FIGS. 4 and 5a-5b show that the attachable computer 101 can be attached to the monitor 102 by belts 103. The belts 103 may be provided with adjustable devices for adjusting the tightness so as to facilitate the attachment of the attachable computer 101 to the monitor 102. FIGS. 6a and 6b show that the attachable computer 101 can be attached to the monitor 102 by hooks 104. FIGS. 7a and 7b show that the attachable computer 101 can be attached to the monitor 102 by double-sided tapes 105. Since the dimension requirements of a monitor have universal standards, the display areas of monitors of the same dimension manufactured by different manufacturers are the same. Therefore, the display area of a monitor will not be affected even the attachable computer 101 is attached to monitors of different manufacturers.

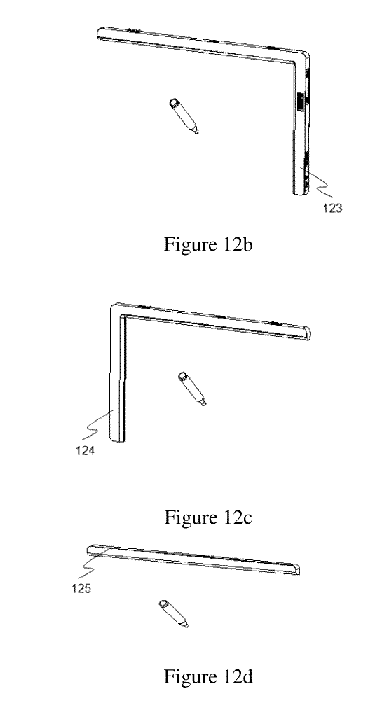

The shape of the attachable computer 101 is not limited to the shape shown in FIG. 1. The attachable computer 101 can be designed into different shapes. FIG. 12a shows an attachable computer 122 in the form of a 3-sided frame. Its frame-structured case may have three side frames. The attachable computer 122 can be used in association with an infrared stylus 121. FIG. 12b shows an attachable computer 123 in the form of a right-angled frame. Its frame-structured case may have two side frames disposed at right angle with respect to each other. The attachable computer 123 can also be used in association with an infrared stylus. FIG. 12c also shows an attachable computer 124 in the form of a right-angled frame. Its frame-structured case may also have two side frames disposed at right angle with respect to each other. The attachable computer 124 can also be used in association with an infrared stylus. FIG. 12d shows an attachable computer 125 in the form of a 1-sided frame. Its frame-structured case may have the shape of a strip. The attachable computer 125 can also be used in association with an infrared stylus.

The frame-structured case of the attachable computer 101 of the present application may be made of aluminium alloy, plastic or any other suitable material. The frame-structured case of the attachable computer may be made of a single material. The frame-structured case of the attachable computer may also be formed of parts made of different materials. For example, the frame-structured case of the attachable computer may be made of metal parts and plastic parts. To make the attachable computer more aesthetic, the frame-structured case may be formed with a decorative outer region.

Decorative designs can be created to produce a more attractive appearance. For example, some transparent regions can be produced.

While the attachable computer has been shown and described with particular references to a number of preferred embodiments thereof, it should be noted that various other changes or modifications may be made without departing from the scope of the appended claims.

What is claimed is:

1. An attachable computer, comprising:
a frame-structured case;
a connector connecting the frame-structured case to a monitor; and
a circuit board, a memory device, a microprocessor, and input and output ports provided in the frame-structured case; and the memory device, the microprocessor, and the input and output ports being connected with the circuit board in electrical signal communication.

2. The attachable computer as claimed in claim 1, wherein the connector is a belt, a hook or a double-sided tape.

3. The attachable computer as claimed in claim 2, wherein the belt is provided with adjustable devices for adjusting a tightness of the belt.

4. The attachable computer as claimed in claim 1, wherein the frame-structured case is in the form of a strip, a right-angled frame, a 3-sided frame or a 4-sided frame.

5. The attachable computer as claimed in claim 1, further comprising an infrared stylus.

6. The attachable computer as claimed in claim 1, wherein the frame-structured case is provided with a sensing module, the sensing module being connected with the circuit board in electrical signal communication, the sensing module producing a touch sensitive area in a region surrounded by the frame-structured case.

7. The attachable computer as claimed in claim 1, wherein the frame-structured case is in the form of a 4-sided frame, and the attachable computer comprises:
two sensing modules provided at an upper left corner and an upper right corner of the frame-structured case respectively and connected with the circuit board in electrical signal communication;
a plurality of light strips provided on three sides of the frame-structured case; and
a control board provided on the frame-structured case; wherein
the sensing module produces a touch sensitive area in a region surrounded by the frame-structured case; and
the control board is configured to calculate a relative coordinate of an object in the region; the object being detected with the sensing modules and the light strips.

8. The attachable computer as claimed in claim 1, wherein the frame-structured case has a shape that matches shape of a monitor's side frames on which the frame-structured case is attached.

9. The attachable computer as claimed in claim 1, wherein a touch screen is provided in a region surrounded by the frame-structured case.

10. The attachable computer as claimed in claim 1, wherein the frame-structured case is provided with a decorative outer region.

11. The attachable computer as claimed in claim 1, the frame-structured case is provided with decorative transparent regions.

12. The attachable computer as claimed in claim 1, wherein the microprocessor, the memory device and the input and output ports are integrated on the circuit board.

13. The attachable computer as claimed in claim 1, wherein the input and output ports are mounted on one side of the frame-structured case, or on a plurality of sides of the frame-structured case.

14. The attachable computer as claimed in claim 1, wherein an operating system conversion switch is provided in the frame-structured case.

15. The attachable computer as claimed in claim 1, wherein the attachable computer is attached to a front of the monitor, or a back of the monitor.

16. The attachable computer as claimed in claim 1, wherein the frame-structured case is made of aluminium alloy or plastic.

17. The attachable computer as claimed in claim 1, wherein the frame-structured case is made of a single material.

18. The attachable computer as claimed in claim 1, wherein the frame-structured case is formed of parts made of different materials.

19. The attachable computer as claimed in claim 18, wherein the frame-structured case is made of metal parts and plastic parts.

20. An attachable computer, comprising:
a frame-structured case;
a connector connecting the frame-structured case to a monitor; and
a plurality of circuit boards connected by data lines, a memory device, a microprocessor, and input and output ports provided in the frame-structured case; and
the memory device, the microprocessor, and the input and output ports being connected with the plurality of circuit boards in electrical signal communication.
